(19) United States
(12) Patent Application Publication
(10) Pub. No.: US 2024/0414019 A1
(43) Pub. Date: Dec. 12, 2024

(54) METHODS AND SYSTEMS FOR MONITORING AND REGULATING VARIOUS MEANS OF COMMUNICATION USING ARTIFICIAL INTELLIGENCE TECHNOLOGY

(71) Applicant: Christopher Barsoum, San Jose, CA (US)

(72) Inventor: Christopher Barsoum, San Jose, CA (US)

(21) Appl. No.: 18/736,277

(22) Filed: Jun. 6, 2024

Related U.S. Application Data
(60) Provisional application No. 63/506,486, filed on Jun. 6, 2023.

(51) Int. Cl. H04L 12/18; G06Q 10/1093

(52) U.S. Cl. CPC H04L 12/1831; G06Q 10/1095

(57) ABSTRACT

Disclosed herein is a method for monitoring and regulating various means of communication using artificial intelligence technology. The method may include receiving at least one meeting data from at least one input device; analyzing the at least one meeting data using at least one artificial intelligence model; generating at least one meeting attribute based on the analyzing; retrieving meeting norms information associated with the meeting; analyzing the meeting norms information and the at least one meeting attribute using at least one second machine learning model; generating a notification based on the analyzing of the meeting norms information and the at least one meeting attribute; transmitting at least one meeting attribute and the notification to at least one user device associated with at least one user; and storing the at least one meeting data, the notification, and the at least one meeting attribute. A corresponding system is also disclosed.

### FIELD OF THE INVENTION

The present invention relates generally to data processing. More specifically, the present invention is methods and systems for monitoring and regulating various means of communication using artificial intelligence technology.

### BACKGROUND OF THE INVENTION

The field of data processing is technologically important to several industries, business organizations, and/or individuals. In particular, the use of data processing is prevalent for monitoring and regulating various means of communication.

Meetings and conversations are essential parts of professional and personal communication. However, it can be challenging to keep track of various aspects of a meeting, such as staying on topic, managing interruptions, and ensuring active participation from all participants. Existing techniques for monitoring and regulating various means of communication are deficient with regard to several aspects. For instance, current technologies often rely on manual monitoring or lack real-time feedback mechanisms, which can result in inefficient meetings or miscommunication.

Therefore, there is a need for improved methods and systems for monitoring and regulating various means of communication that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a method for monitoring and regulating various means of communication using artificial intelligence technology is disclosed. Further, the method may include receiving, using a communication device, at least one meeting data from at least one input device. Further, the method may include analyzing, using a processing device, the at least one meeting data using at least one artificial intelligence model. Further, the method may include generating, using the processing device, at least one meeting attribute based on the analyzing. Further, the method may include retrieving, using a storage device, meeting norms information associated with the meeting. Further, the method may include analyzing, using the processing device, the meeting norms information and the at least one meeting attribute using at least one second machine learning model. Further, the method may include generating, using the processing device, a notification based on the analyzing of the meeting norms information and the at least one meeting attribute. Further, the method may include transmitting, using the communication device, at least one meeting attribute and the notification to at least one user device associated with at least one user. Further, the method may include storing, using the storage device, the at least one meeting data, the notification, and the at least one meeting attribute.

In further embodiments, a system for monitoring and regulating various means of communication using artificial intelligence technology is disclosed. Further, the system may include a communication device configured for receiving at least one meeting data from at least one input device. Further, the communication device may be configured for transmitting at least one meeting attribute and notification to at least one user device associated with at least one user. Further, the system may include a processing device configured for analyzing the at least one meeting data using at least one artificial intelligence model. Further, the processing device may be configured for generating at least one meeting attribute based on the analyzing. Further, the processing device may be configured for analyzing meeting norms information and the at least one meeting attribute using at least one second machine learning model. Further, the processing device may be configured for generating the notification based on the analyzing of the meeting norms information and the at least one meeting attribute. Further, the system may include a storage device configured for retrieving meeting norms information associated with the meeting. Further, the storage device may be configured for storing the at least one meeting data, the notification, and the at least one meeting attribute.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

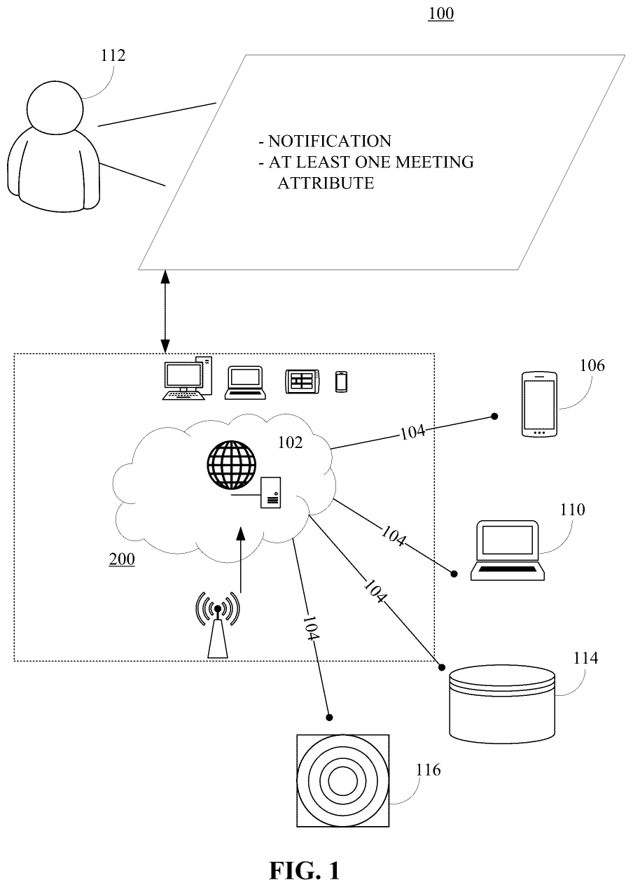

FIG. 2 is a block diagram of a computing device for implementing the methods disclosed herein, in accordance with some embodiments.

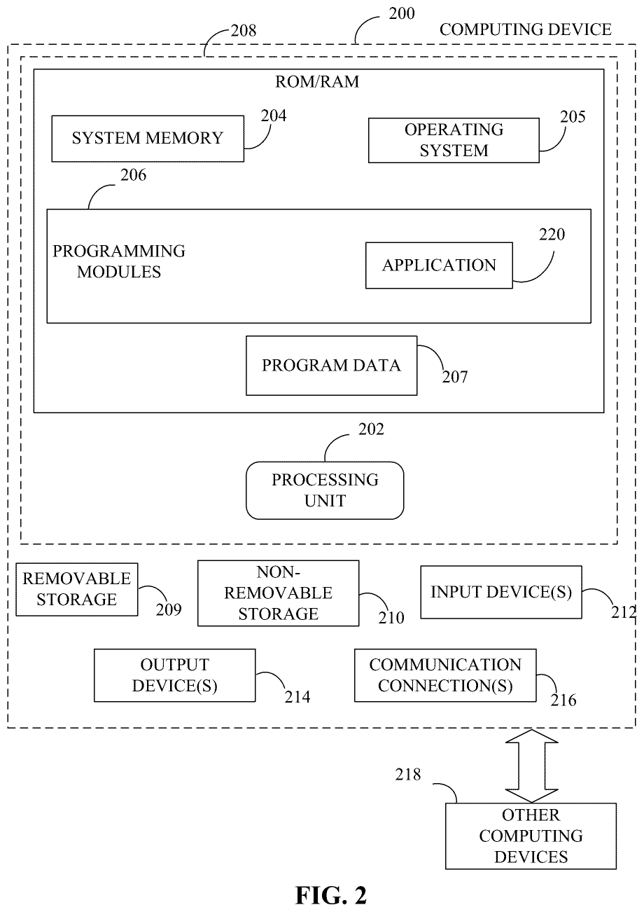

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for monitoring and regulating various means of communication using artificial intelligence technology, embodiments of the present disclosure are not limited to use only in this context.

### Overview

The present disclosure describes methods and systems for monitoring and regulating various means of communication using artificial intelligence technology. Further, the disclosed system may use artificial technology for conversation monitoring, regulation, and providing notifications. Further, the disclosed system may use AI (Artificial Intelligence) technology that monitors and detects various aspects of meetings or conversations, such as deviations from an agenda, heated discussions, dominating behavior, interruptions, presentation of main points, deliverables, meeting summaries, and participant engagement and provides timely notifications or reminders to participants.

The disclosed system may provide an AI-based technology that monitors the meetings or conversations in real time and provides timely notifications or reminders to participants when certain events occur. The disclosed system uses various techniques, such as speech recognition, natural language processing, video analysis, and email integration, to detect deviations from the agenda, heated discussions, dominating behavior, interruptions, presentation of main points, deliverables, meeting summaries, and participant engagement. The disclosed system may send the notifications or reminders to participants via a universal reminder, spoken reminder, individual messages, confirmation pop-ups, emails, or notifications with sounds, based on the detected events. Further, individual notification settings, such as frequency, sensitivity, etc., may be changed by individual participants.

Further, the disclosed system may be configured for performing deviation detection. Further, the disclosed system uses speech recognition and natural language processing techniques to analyze meeting conversations and detect when a meeting or conversation goes off track from the agenda. When a deviation is detected, the system sends a universal reminder to all participants or a reminder to some participants as configured to bring the discussion back on track. The reminder may be audio, visual, or by other means that can be felt by the human skin, such as applying pressure to the skin.

Further, the disclosed system may be configured for performing heated discussion detection. Further, the system analyzes audio and video inputs to detect when a meeting or conversation becomes heated or emotionally charged. When a heated discussion is detected, the system may send messages for example to the participants involved to remind them to maintain a professional tone and avoid conflicts.

Further, the disclosed system may be configured for performing dominating behavior detection: The system analyzes meeting dynamics and participant engagement to detect when a participant is dominating the conversation or not allowing others to speak. When the dominating behavior is detected, the system may send a reminder for example to the dominating participant to allow others to participate and share their thoughts.

Further, the disclosed system may be configured for performing interruption detection. The system uses audio analysis and video analysis techniques to detect when a participant interrupts another participant while speaking. When an interruption is detected, the system may send a reminder or confirm with the interrupting participant, whether the interruption is intended.

Further, the disclosed system may be configured for providing main points presentation. Further, the system analyzes meeting content and identifies key points or highlights. Further, the system may display these main points on the screen in real-time, or announce it by other means providing visual cues to participants and helping them stay focused on important topics.

Further, the disclosed system may be configured for providing deliverables notification. Further, the system integrates with email systems and may identify deliverables or action items mentioned during the meeting. Further, the disclosed system may automatically send emails to respective people or teams, notifying them of their assigned tasks or responsibilities.

Further, the disclosed system may be configured for providing a meeting summary. Further, the system generates a summary of the meeting, including key discussion points, decisions, and action items. Further, the disclosed system may automatically send the meeting summary to a preset email list, providing an overview of the meeting outcomes to relevant stakeholders.

Further, the disclosed system may be configured for performing participant engagement detection. Further, the system uses video analysis techniques to detect when a participant's eyes are closed for an extended period of time, or when a participant appears bored/disinterested or not smiling while other participants are, indicating possible disengagement or distraction. When closed eyes are detected, the system may turn off the participant's camera, send a notification, and play a sound to wake up the participant and re-engage in the meeting. When boredom or lack of facial expression engagement is detected, the system may send a notification, turn off the participant's camera, and/or play a sound to re-engage in the meeting.

All the above-mentioned features and the sensitivity to inputs of the features can be adjusted via individual participant and moderator settings.

The system may notify the participants using audio and/or visual means, and/or by some other means that the human skin can sense e.g. applying pressure to the human skin.

The system may be used in virtual meetings, in-person meetings, phone calls, casual home conversations, business meetings, academic lectures, therapy sessions, customer service calls, personal conversations, and messaging platforms. The features of the system may vary according to the type of conversation or meeting. The system may also be integrated with communication systems such as telephones. The specific applications and implications of the system are provided as examples and do not limit the scope of the patent.

Further, the disclosed system may include an AI-technology-based meeting monitoring and notification system that offers real-time monitoring and notification features to enhance the efficiency and effectiveness of meetings or conversations. The system detects deviations from the agenda, heated discussions, dominating behavior, interruptions, main points presentation, deliverables notification, meeting summaries, and participant engagement, and sends timely reminders or notifications to participants via various means. The system may be used in virtual meetings, in-person meetings, phone calls, casual home conversations, and messaging platforms, with features varying accordingly. Additionally, the system provides statistics at the end of each meeting, including who talked the most, who didn't talk, whose video was on, and for how long, etc. This technology has the potential to significantly improve meeting outcomes, communication, and collaboration among participants.

Further, in some embodiments, the disclosed system may be configured to give analysis to individuals after the meeting ends. Further, the disclosed system may be used, for instance, if an individual does not want to be distracted during the meeting, but wants to learn the analysis afterward, in order to work on improving certain areas, based on the analysis, for subsequent meetings or conversations.

Further, in an instance, the disclosed system may be used for in-person conversations, meetings, and speech practices. The system may be built into an external device.

Further, in some embodiments, the disclosed system may be used for messaging, for example, to scan and analyze a message before it's sent, and to notify a sender if the tone is heated, for example, among other variables the message can be scanned for.

Further, in some embodiments, every notification and analysis setting may be configured by both individual users/participants, and moderators.

Further, in some embodiments, the disclosed system may be configured so that the notification contains customized text. This may be used, for example, if an individual or moderator wishes to get a motivational/encouraging quote when the individual appears bored, for instance. Further, the notification may also include relevant information, such as what was discussed while the individual appeared asleep or not focused, how much longer the meeting will take, etc. These may all be configured for each type of notification via participant and moderator settings.

Further, in some embodiments, the disclosed system, using a facial expression recognition AI, may also detect, and notify accordingly, when one or more participants/users appear bored, frowning, or other configurable features. Further, the disclosed system may be configured to detect, and notify accordingly when one or more participants/users have an unusual video appearance, such as hair sticking up or if a pet or human enters the video. Further, the disclosed system may be configured to detect and notify accordingly when one or more participants/users have inappropriate audio input. If these notifications are ignored/not dismissed, the system may be configured to turn off said participant's video and/or microphone.

By way of non-limiting example, the online platform for monitoring and regulating various means of communication using artificial intelligence technology may be hosted on a centralized server, such as, for example, a cloud computing service. The centralized server may communicate with other network entities, such as, for example, a mobile device (such as a smartphone, a laptop, a tablet computer, etc.), other electronic devices (such as desktop computers, server computers, etc.), databases, and sensors over a communication network, such as, but not limited to, the Internet. Further, users of the online platform may include relevant parties such as, but not limited to, end-users, service providers, and administrators. Accordingly, in some instances, electronic devices operated by the one or more relevant parties may be in communication with the online platform.

A user, such as the one or more relevant parties, may access the online platform through a web-based software application or browser. The web-based software application may be embodied as, for example, but not be limited to, a website, a web application, a desktop application, and a mobile application compatible with a computing device.

In further embodiments, a method for monitoring and regulating various means of communication using artificial intelligence technology is disclosed. Further, the method may include receiving, using a communication device, at least one meeting data from at least one input device. Further, the at least one meeting data may be associated with a meeting. Further, the at least one meeting data may include an image, a video, an audio, etc. Further, the at least one input device may include a sensor such as an image sensor, an audio sensor, etc. configured for generating the at least one meeting data.

Further, the method may include analyzing, using a processing device, the at least one meeting data using at least one artificial intelligence model. Further, the at least one artificial intelligence model may be based on at least one artificial intelligence algorithm.

Further, the method may include generating, using the processing device, at least one meeting attribute based on the analyzing. Further, the at least one meeting attribute may include a type of discussion, behavior of participants in the meeting, interruptions, presentation points, deliverables, meeting summaries, and participant engagement.

Further, the method may include retrieving, using a storage device, meeting norms information associated with the meeting. Further, the meeting norms information may include criteria and norms based on which the meeting should be conducted or held.

Further, the method may include analyzing, using the processing device, the meeting norms information and the at least one meeting attribute using at least one second machine learning model.

Further, the method may include generating, using the processing device, a notification based on the analyzing of the meeting norms information and the at least one meeting attribute. Further, the notification may indicate if the meeting is held based on the meeting norms information. Further, the notification may include a reminder for one or more participants or people in the meeting to facilitate the meeting to be held according to the meeting norms information. The reminder may be audio, visual, or by other means that can be felt by the human skin, such as applying pressure to the skin. Further, the notification may include a measure or recommendation that may allow the one or more participants to conduct the meeting based on the meeting norms information.

Further, the method may include transmitting, using the communication device, at least one meeting attribute and the notification to at least one user device associated with at least one user. Further, the at least one user device may include a smartphone, a tablet, a laptop, etc. Further, the at least one user may include an individual, an institution, and an organization that may want to perform monitoring and regulating various means of communication using artificial intelligence technology.

Further, the method may include storing, using the storage device, the at least one meeting data, the notification, and the at least one meeting attribute.

Further, in some embodiments, the at least one artificial intelligence model may be configured for performing speech recognition, natural language processing, and video analysis.

Further, in some embodiments, the at least one second artificial intelligence model may be configured for detecting deviation from an agenda of the meeting, heated discussions, dominating behavior, interruptions, presentation of main points, deliverables, meeting summaries, and participant engagement.

In further embodiments, a system for monitoring and regulating various means of communication using artificial intelligence technology is disclosed. Further, the system may include a communication device configured for receiving at least one meeting data from at least one input device. Further, the at least one meeting data may be associated with a meeting. Further, the at least one meeting data may include an image, a video, an audio, etc. Further, the at least one input device may include a sensor such as an image sensor, an audio sensor, etc. configured for generating the at least one meeting data. Further, the communication device may be configured for transmitting at least one meeting attribute and notification to at least one user device associated with at least one user. Further, the at least one user device may include a smartphone, a tablet, a laptop, etc. Further, the at least one user may include an individual, an institution, and an organization that may want to perform monitoring and regulating various means of communication using artificial intelligence technology.

Further, the system may include a processing device configured for analyzing the at least one meeting data using at least one artificial intelligence model. Further, the at least one artificial intelligence model may be based on at least one artificial intelligence algorithm. Further, the processing device may be configured for generating at least one meeting attribute based on the analyzing. Further, the processing device may be configured for analyzing meeting norms information and the at least one meeting attribute using at least one second machine learning model. Further, the processing device may be configured for generating the notification based on the analyzing of the meeting norms information and the at least one meeting attribute. Further, the notification may indicate if the meeting is held based on the meeting norms information. Further, the notification may include a reminder for one or more participants in the meeting to facilitate the meeting to be held according to the meeting norms information. Further, the notification may include a measure or recommendation that may allow the one or more participants to conduct the meeting based on the meeting norms information.

Further, the system may include a storage device configured for retrieving meeting norms information associated with the meeting. Further, the meeting norms information may include criteria and norms based on which the meeting should be conducted. Further, the storage device may be configured for storing the at least one meeting data, the notification, and the at least one meeting attribute.

Further, in an instance, if a participant, falls asleep, interrupts, gets heated, frowns, or seems unfocused, the notification may be sent to the participant.

Further, in some embodiments, the system may be used for only one individual. For instance, the system may be configured to regulate, monitor, and analyze lecture recordings or voice messages.

A system consistent with an embodiment of the disclosure may include a computing device or cloud service, such as computing device. In a basic configuration, computing device may include at least one processing unit and a system memory. Depending on the configuration and type of computing device, system memory may comprise, but is not limited to, volatile (e.g. random-access memory (RAM)), non-volatile (e.g. read-only memory (ROM)), flash memory, or any combination. System memory may include operating system, one or more programming modules, and may include program data. Operating, for example, may be suitable for controlling computing device's operation. In one embodiment, programming modules may include image-processing module, machine learning module and/or image classifying module. Furthermore, embodiments of the disclosure may be practiced in conjunction with a graphics library, other operating systems, or any other application program and is not limited to any particular application or system.

Computing device may have additional features or functionality. For example, computing device may also include additional data storage devices (removable and/or non-removable) such as, for example, magnetic disks, optical disks, or tape. Computer storage media may include volatile and nonvolatile, removable and non-removable media implemented in any method or technology for storage of information, such as computer-readable instructions, data structures, program modules, or other data. System memory, removable storage, and non-removable storage are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device. Any such computer storage media may be part of device. Computing device may also have input device(s) such as a keyboard, a mouse, a pen, a sound input device, a touch input device, a location sensor, a camera, a biometric sensor, etc. Output device(s) such as a display, speakers, a printer, etc. may also be included. The aforementioned devices are examples and others may be used.

Computing device may also contain a communication connection that may allow device to communicate with other computing devices, such as over a network in a distributed computing environment, for example, an intranet or the Internet. Communication connection is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory, including operating system. While executing on processing unit, programming modules (e.g., application such as a media player) may perform processes including, for example, one or more stages of methods, algorithms, systems, applications, servers, databases as described above. The aforementioned process is an example, and processing unit may perform other processes. Other programming modules that may be used in accordance with embodiments of the present disclosure may include sound encoding/decoding applications, machine learning application, acoustic classifiers, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

The following is claimed:

1. A method for monitoring and regulating various means of communication using artificial intelligence technology, comprising:
receiving, using a communication device, at least one meeting data from at least one input device;
analyzing, using a processing device, the at least one meeting data using at least one artificial intelligence model;
generating, using the processing device, at least one meeting attribute based on the analyzing;
retrieving, using a storage device, meeting norms information associated with the meeting;
analyzing, using the processing device, the meeting norms information and the at least one meeting attribute using at least one second machine learning model;
generating, using the processing device, a notification based on the analyzing of the meeting norms information and the at least one meeting attribute;
transmitting, using the communication device, at least one meeting attribute and the notification to at least one user device associated with at least one user; and
storing, using the storage device, the at least one meeting data, the notification, and the at least one meeting attribute.

2. A system for monitoring and regulating various means of communication using artificial intelligence technology, comprising:
a communication device configured for:
receiving at least one meeting data from at least one input device; and
transmitting at least one meeting attribute and notification to at least one user device associated with at least one user;
a processing device configured for:
analyzing the at least one meeting data using at least one artificial intelligence model;
generating at least one meeting attribute based on the analyzing;
analyzing meeting norms information and the at least one meeting attribute using at least one second machine learning model; and
generating the notification based on the analyzing of the meeting norms information and the at least one meeting attribute;
a storage device configured for:
retrieving meeting norms information associated with the meeting; and
storing the at least one meeting data, the notification, and the at least one meeting attribute.
